(19) United States
(12) Patent Application Publication
(10) Pub. No.: US 2024/0415315 A1
(43) Pub. Date: Dec. 19, 2024

(54) BEVERAGE POD SYSTEM WITH IMPROVED SEAL

(71) Applicant: SOCIETE DES PRODUITS NESTLE S.A., Vevey (CH)

(72) Inventors: DIDIER VUAGNIAUX, Gimel (CH); ALEXANDRE KOLLEP, Lutry (CH)

(21) Appl. No.: 18/720,962

(22) PCT Filed: Dec. 19, 2022
(86) PCT No.: PCT/EP2022/086674

§ 371 Date: Jun. 17, 2024

(30) Foreign Application Priority Data
Dec. 21, 2021 (EP) 21216610.2

(51) Int. Cl. A47J 31/06

(52) U.S. Cl. CPC A47J 31/0668

(57) ABSTRACT

The invention concerns a system of pod and a device for extracting a beverage ingredient by supplying an extraction liquid such as heated water into in the pod and comprising:—upstream and downstream pod enclosing parts (1, 2) relatively translatable along a longitudinal axis (XX′) between an open position for inserting and/or ejecting the pod (3) and a closed position for forming an extraction chamber (5) enclosing the pod during extraction,—the upstream part (2) defining a cage (21) and bearing an upstream piercing arrangement(22) for opening the bottom wall (313) of the pod and a liquid injector (25),—the downstream part (1) defining a plate transverse to the longitudinal axis (XX′), said plate comprising a downstream plane piercing arrangement (12) for opening the lid (32) of the pod, and a peripheral area (13), and wherein the periphery of the opened end (211) of the cage (21) defined by the upstream enclosing part is covered by a seal (24) comprises a ridge (241) rising in the downstream direction, and wherein, in the closed position of the downstream and the upstream enclosing parts (1, 2) a central part of the flange of the pod is pinched by the ridge (241) of the seal of the upstream enclosing part against the peripheral area (13) of the plate of the downstream part. FIG. 3A

### FIELD OF THE INVENTION

The present invention relates to the field of preparation of beverages with a system including a single-serve container comprising a beverage ingredient and a machine that has an extraction chamber in which the container can be inserted, extracted and from which it can be ejected.

### BACKGROUND OF THE INVENTION

Single serve containers for the automatic preparation of beverages encompass various formats of containers that can be relatively soft or flexible, such as pods, and made of any material, recyclable or non-recyclable, biodegradable or non-biodegradable, such as aluminium, plastic, filter paper.

One problem encountered with the systems extracting beverages from said pods is the handling of the pod in an extraction device, specifically the closing of the chamber around the pod to perform the extraction process and then the proper ejection of the pod from the chamber. The pod usually has to be positioned by the user in a housing, then the device is closed manually or automatically around the pod.

It is important to correctly position the pod so that the device closes properly around the latter and to form a good seal to ensure good conditions of extraction. Bad positioning may damage the pod, and thus affect the conditions of extraction. The loading must also be as rapid as possible and not require excessive manipulations.

Finally, at the end of the beverage preparation, the pod shall be easily ejected without risk of false orientation and machine blocking.

EP 1859714 and WO 2013/026844 describe a system extracting beverages from soft or flexible pods presenting specific characteristics:
the pods are made of aluminium or plastic materials,
the pods present a symmetrical shape relatively to the plane comprising the flange of the pod,
the pods always present the same shape, dimension and volume and the extraction chamber is designed for receiving this single type of pod shape.

WO 2020/089404 describes another system extracting beverages from soft or flexible pods presenting other characteristics:
the pods present asymmetrical shape relatively to the plane comprising the flange of the pod,
different pods presenting different shapes and volumes can be used and the extraction chamber is designed for receiving these different pods,
the pods can be made of aluminium.

The extraction device is provided with an extraction chamber configured to adapt its size to the shape and volume of the pod introduced.

Due to the asymmetrical shape and the use of different sizes of pods, the extraction device of the above cited systems designed for single size of symmetrical pods cannot be used.

In addition, in order to respect environment, it is required today to use pods made of biodegradable and/or compostable materials, in particular made essentially of thick paper.

These new materials lead to particular properties and consequently to specific problems during the beverage preparation and the handling of the pod in the extraction device.

In addition, in order to provide paper pods that are home compostable and that guarantee good handling within the extraction device simultaneously, specific paper materials were defined. The materials present a thickness that is bigger than the thickness of usual materials like aluminium or paper filter.

Due to said thickness of the paper material, during the shaping of the body of the pod, wrinkles are created on all the periphery of the flange. These wrinkles directly impact the tightness of the extraction chamber during the beverage preparation because they provide exist paths for the liquid injected in the cage.

An object of the invention is to address at least the above existing problems.

### SUMMARY OF THE INVENTION

In a first aspect of the invention, there is provided a system comprising an extraction device and a pod, wherein said pod comprises:
a pod body, said pod body comprising:
   a side wall and a bottom wall defining a chamber, said chamber extending axially between the bottom and a top opening,
   a circumferential annular flange projecting radially outward from the top opening, said flange comprising an upper surface opposite to the chamber with respect to the opening, said pod body containing a beverage ingredient, and
a top lid attached to the upper surface of the circumferential flange, said top lid closing the top opening of the pod body, and

wherein said extraction device comprises
upstream and downstream pod enclosing parts relatively translatable along a longitudinal axis (XX′) between an open position for inserting and/or ejecting the pod and a closed position for forming an extraction chamber enclosing the pod during extraction,
the upstream part defining a cage for enclosing the pod body and bearing an upstream piercing arrangement for opening the bottom wall of the pod body and a liquid injector, and
the downstream part defining a plate transverse to the longitudinal axis (XX′), said plate comprising:
   a downstream plane piercing arrangement for opening the lid of the pod, and
   a peripheral area, and
an insertion section for inserting the pod in the device, said insertion section being designed to position the pod with the lid facing the downstream piercing arrangement, and wherein the periphery of the opened end of the cage defined by the upstream enclosing part is covered by a seal, and

said ridge is configured to be pressed against the peripheral area of the plate of the downstream part when the first and second enclosing parts are in the closed position, and said seal comprises a ridge, said ridge rising in the upstream direction, and wherein, in the closed position of the downstream and the upstream enclosing parts, a central part of the flange of the pod is pinched by the ridge of the seal of the upstream enclosing part against the peripheral area of the plate of the downstream part.

In the system, the device for extracting a beverage ingredient is typically comprised in a beverage preparation machine configured for receiving pods. For instance, the machine is a coffee, tea, chocolate or soup preparation machine, preferably a coffee machine. In particular, the machine is arranged for preparing within the extraction chamber a beverage by passing water, preferably hot, or another liquid through a pod containing an ingredient of the beverage to be prepared, such as roasted ground coffee or tea leaves or instant coffee or instant tea or chocolate or cacao or milk powder or dehydrated soup. In the preferred embodiment, the beverage ingredient is roasted and ground coffee.

In the system, preferably, the body and the lid of the pod are made of paper material. The paper material provides the pod with biodegradable and/or compostable properties. In one preferred embodiment, the paper material is a multilayer paper material comprising a layer of paper coated with at least a plastic film, preferably a compostable plastic film. This compostable plastic film can be a multilayer plastic film. This film can provide additional properties such as air barrier and sealants to avoid delamination.

Preferably, the body is made of a paper material presenting a thickness of at least 100 μm, preferably at least 120 μm.

Preferably, the paper material can present a grammage comprised between 80 and 150 g/m² Preferably, the pod body is manufactured by forcing a disc of paper material in a mould.

In particular, the pod body can be formed from a disc of paper material by a blank sliding process, by a stamping process or deep-drawing process.

Such manufacture leads to the presence of wrinkles on the pod, particularly when the paper material is thick. Usually, with a paper material such as described above, the bottom face of the body flange can comprise wrinkles presenting a depth comprised between about 25 μm and 200 μm, in particular for a pod body presenting a diameter of about 48 mm.

Preferably the pod body of the system is manufactured by stamping a disc of paper material and the bottom face of the body flange comprises wrinkles.

In addition, such manufacture of the body can lead to inconsistency on the diameter of the body, particularly when the paper material is thick.

The extraction device of the system is configured for extracting a beverage ingredient contained in the pod by supplying an extraction liquid such as water into the pod. The device comprises upstream and downstream pod enclosing parts relatively movable between an open position for inserting and/or ejecting such pod and a closed position for forming an extraction chamber enclosing the pod during beverage ingredient extraction.

Typically, the pod can be inserted into the device from above under the effect of gravity. Ejection or removal of the pod upon reopening of the enclosing parts may also be driven by gravity.

The upstream and downstream pod enclosing parts are relatively translatable along a longitudinal axis (XX′) between an open position for inserting and/or ejecting the pod and a closed position for forming an extraction chamber enclosing the pod during extraction.

The upstream part defines an empty cage or cavity for enclosing the pod body and comprises an upstream piercing arrangement in the form of one or more piercers for piercing the bottom wall of the inserted pod and at least one liquid injector for supplying liquid through the pierced bottom wall of the pod.

This upstream piercing arrangement can comprise piercers in the form of blades. These blades can be designed and positioned to pierce the wall of the bottom of the pod body when the upstream and downstream pod enclosing parts are brought to the closed position. The liquid injector, such as a shower at the upstream part of the cage, can introduce the extracting liquid through the pre-pierced openings.

In an alternative, this upstream piercing arrangement can comprise at least one hollow needle configured to pierce the wall of the bottom of the pod body and said hollow needle(s) can comprise an internal axial channel for guiding the extracting liquid in the chamber of the pod body.

The downstream part defines a plate transverse to the longitudinal axis. Accordingly, this plate extends along a plane that is perpendicular to the longitudinal axis XX′. This plate of the downstream part comprises a downstream plane piercing arrangement for opening the lid of the pod when the extracting liquid is introduced inside the pod. Usually, this downstream plane piercing arrangement is designed for opening the lid by relative engagement with the lid under the effect of the rise in pressure of the injected liquid in the pod body chamber and inflation of the lid against the piercing arrangement. This downstream plane piercing arrangement may comprise a rigid plate comprising opening elements such as spikes, that can present the shape of cones or pyramids, optionally truncated at their ends, on its surface turned to the lid. In addition, the plate comprises traversing holes to evacuate the beverage dispensed from the opened lid to a tube or nozzle collecting and dispensing beverage to a drinking cup.

In addition, the plate of the downstream part comprises a peripheral area that extends around the whole periphery of the downstream plane piercing arrangement. Consequently, this peripheral area extends in the same plane as the downstream plane piercing arrangement.

The device comprises an insertion section for inserting the pod in the device. Generally, this section is positioned above the upstream and downstream pod enclosing parts so that the pod is inserted by gravity between these two parts. This insertion section is designed so that the user is urged to position the pod with its lid facing the downstream piercing arrangement.

Preferably, this insertion section can comprise a recognition device to recognise or identify the pod that is introduced inside the extraction device. The recognition device can comprise:
a pod temporary blocking means to block the pod in a temporary recognition position, and
a device to recognise the pod blocked in this temporary recognition position.

The recognition device is configured to enable the pod temporary blocking means to let the pod fall to the pod holder of the extraction device once the pod has been recognised.

In the extraction device, the periphery of the opened end of the cage defined by the upstream enclosing part is covered by a seal. This seal is configured to be pressed against the peripheral area of the plate of the downstream part when the first and second enclosing parts are in the closed position.

In addition, this seal comprises a ridge that extends along the periphery of the seal. This ridge of the seal rises in the downstream direction. This ridge is dimensioned and positioned relatively to the downstream enclosing part and the pod hold in the closed extraction chamber so that this ridge pinches a central part of the flange of the pod against the peripheral area of the plate of the downstream part.

Preferably, this ridge is continuous and pinches the whole periphery of the flange continuously. Accordingly, in the closed position of the enclosing parts, the flange of the pod is pressed between the seal and the peripheral area and is pinched strongly by the ridge. As a result, in the flange, the paths for liquid created by the presence of wrinkles around the flange of the pod are closed and tightness is obtained.

Preferably, the peripheral area of the downstream enclosing part comprises a groove and, when the upstream and downstream pod enclosing parts are in the closed position, the ridge faces said groove.

Accordingly, in the closed position, the central part of the flange is forced by the ridge in the groove, and consequently, an even stronger barrier to liquid is obtained because wrinkles can be stretched out between the ridge and the groove with the effect of flattening the material and reinforcing the tightness function of the seal.

Preferably, the shape of the groove can be conformal to the shape of the ridge of the seal.

Usually, the seal is made of a deformable and elastic material such as an elastomer. The seal can be made of an EPDM rubber.

Preferably, the extraction device can comprise a pod holder attached to the peripheral area of the downstream part. While being attached, that is to say supported by the peripheral area, the pod holder can be moved between two positions:
a first receiving position for receiving and holding the lid of the pod in front of the downstream plane piercing arrangement, and
a second retracted position at the lateral sides of the downstream plane piercing arrangement.

Usually, the pod holder comprises a pair of retaining and positioning elements. In the receiving position of the pod holder, these elements retain the pod vertically or slightly inclined versus vertical and position the pod in front of the downstream plane piercing arrangement.

Each of these pair of elements of the pod holder can comprise a lower holding surface and a transverse arc-shaped ridge. This pair of elements are configured so that in their receiving position:
the lower holding surfaces of these elements retain the pod vertically as it falls by gravity inside the device from the insertion section in between the two enclosing parts. These lower holding surfaces are positioned so that the lid of the pod is aligned with the downstream piercing arrangement,
the transverse arc-shaped ridges retain the pod longitudinally so that the lid of the pod remains essentially parallel or slightly inclined away from the downstream plane piercing arrangement. Preferably, these ridges extend in a transverse plane that is slightly inclined relative to the plane of the downstream plane piercing arrangement, the lower parts of the elements being closer to the downstream part than the upper parts. This inclination provides a larger upper space for the insertion of the pod from the insertion section down to the pod holder and limits the risk of wrong road for the pod. Due to the fact that the pod presents asymmetrical shape versus the plane of the lid, the pod cannot stand in a balanced position when its lid is vertically oriented, and even less for the biggest pods, since its centre of gravity lies in the middle of the pod body.

This inclination provides the additional advantage of limiting the movement of the pod inside the pair of elements when they are moved from the receiving to the retracted position since during said movement, the path of movement of the part of the pod laying on the lower holding surfaces is kept very short.

The transverse arc-shaped ridges can extend in a transverse plane that is inclined by few degrees relatively to the plane of the plane piercing arrangement.

Generally, the elements of the pair present symmetric shapes versus the vertical plane comprising the longitudinal axis XX′ extending through the centre of the downstream piercing arrangement.

The pair of retaining and positioning elements are movable between two positions depending on the status of the operation of the extracting device:
in the status of insertion of a new pod, the pair of retaining and positioning elements is in a receiving position for receiving and holding the pod. The pair of elements retain the pod in front of the downstream plane piercing arrangement. The pair of elements extend in front of the downstream part, in particular in front of the peripheral area of the downstream part. The pair of transverse arc-shaped ridges are preferably inclined relative to the plane of the downstream plane piercing arrangement.
in the status of extraction of the pod (that is introduction of liquid in the pod), the pair of elements are in a retracted position at the lateral sides of the downstream plane piercing arrangement.

In addition, the pair of retaining and positioning elements are pushable from the receiving position to the retracted position by the upstream enclosing part when said upstream enclosing part is translated longitudinally from the open position to the closed position.

Consequently, depending on the operation step implemented in the extraction device, the pair of retaining and positioning elements are able either to interact with the pod by retaining it or to stop any interaction with the pod which can interact freely with the cage or can be ejected.

Preferably, the retaining and positioning elements move from the receiving position to the retracted position along diverging directions.

By “diverging directions”, it is meant that the directions followed by the first retaining and positioning element and the second retaining and positioning element are not parallel and that the distance between these elements is greater in the retracted position than in the receiving position.

Consequently, in the receiving position, the pair of retaining and positioning elements define an intermediate space that is sized to retain at least the smaller pods, that is the pods presenting the smallest diameters due to the inconsistent manufacturing. When these elements are pushed by the upstream enclosing part from this receiving position to the retracted position, the diverging directions cause the space between these elements to increase which guarantees:
that the flanges of the pods presenting the biggest diameters do not remain pinched by these elements in the retracted position, and
that the upstream enclosing part is able to lean on the downstream enclosing part for forming the extraction chamber in an homogeneous manner all along the periphery of the pod flange.

A flange that would be partially pinched in one of the retaining and positioning elements during the movement the closure of the chamber would lead to inequal closure, liquid leaking, impossibility to get pressure increase and correct extraction of the pod.

The risk of pinching is particularly increased with pods presenting inconsistent diameter even if the tolerance is small.

The diverging directions of the elements during movement to the retracted position avoid the risk of pinching.

Generally, when the retaining and positioning elements move from the receiving position to the retracted position, these elements can diverge transversally by a dimension corresponding to the tolerance about the diameters of the manufactured pods. For example, for a tolerance of more or less 1 mm, each element can diverge transversally by at least 0.5 mm, preferably 1 mm during the movement of the retaining elements from the receiving position to the retracted position.

Preferably, the pod holder comprises guiding parts that are configured to guide the movements of the retaining and positioning elements between the retaining position and the retracted position. These guiding parts can comprise slopes oriented to slide along surfaces of the peripheral area of the downstream enclosing part according to diverging directions.

Preferably, the pair of retaining and positioning elements are made of one single piece of material.

As a result, both elements are moved simultaneously and their movements are guided better.

In particular the pair of retaining and positioning elements can be linked by a transversal bridge extending below the downstream piercing arrangement.

Preferably, the pod holder is able to be locked in the peripheral area of the downstream enclosing part and to remain locked until the operation of ejection of the pod is finished, preferably until a new pod is introduced in the insertion section.

By locking the pod holder in the peripheral area during the complete operation of ejection of the pod, there is no risk that the pair of retaining and positioning elements move during the movement of the upstream pod enclosing part back to the open position, and then no risk that at least one of the pair of retaining and positioning elements pinch or retain the flange of the extracted pod while the cage progressively liberates the extracted pod.

Preferably, the side of the upstream enclosing part facing the downstream enclosing part comprises rising elements configured to push the pair of retaining and positioning elements during the longitudinal translation of the upstream enclosing part from the open position to the closed position.

The extraction device can be part of a beverage preparation machine. Generally, this beverage machine comprises a liquid supply system connected to the upstream enclosing part. This liquid supply system can comprise:
a liquid supply such as a liquid tank,
pumping means to drive liquid form the liquid supply to the extraction device,
heating and/or cooling means to adapt the temperature of the liquid before it is introduced inside the pod.

The liquid is usually water.

This beverage machine can comprise recognition means as mentioned above.

This beverage machine usually comprises a motor to actuate the movement of the enclosing parts of the extraction device

Usually, this beverage machine comprises a control unit configured to control the movement of the enclosing parts of the extraction device and the supply of liquid to the extraction device.

The control unit can be configured to control the recognition operation of the recognition device if present or to display information to the user.

In another aspect, there is provided the use of a pod for preparing a beverage in a system or an extraction device or a beverage machine such as described above, said pod comprising:
a pod body, said pod body comprising:
   a side wall and a bottom wall defining a chamber, said chamber extending axially between the bottom and a top opening,
   a circumferential annular body flange projecting radially outward from the top opening, said body flange comprising a top face opposite to the chamber with respect to the opening, said pod body containing a beverage ingredient, and
a top lid comprising a peripheral annular area attached to the top face of the body flange, said top lid closing the top opening of the pod body.

Preferably, the body and the lid of the pod are made of paper material.

In one preferred embodiment, the paper material is a multilayer paper material comprising a layer of paper coated with at least a plastic film, preferably a compostable plastic film. This compostable plastic film can be a multilayer plastic film. This film can provide additional properties such as air barrier and sealants to avoid delamination.

The multilayer paper material of the lid can comprise an additional layer of material to facilitate interaction with the downstream plate piercing arrangement, specifically avoid remaining attached to said downstream plate piercing arrangement Preferably, the body is made of a paper material presenting a thickness of at least 100 μm, preferably at least 120 μm.

Preferably, the paper material presents a grammage comprised between 80 and 150 g/m².

Preferably, the pod body is manufactured by forcing a disc of paper material in a mould. In particular, the pod body can be formed from a disc of paper material by a blank sliding process, by a stamping process or a deep-drawing process.

Such manufacture of the body generally leads to inconsistency on the diameter of the body, particularly when the paper material is thick.

Such manufacture generally leads to the presence of wrinkles o the pod, particularly when the paper material is thick. Usually, with a paper material such as described above, the bottom face of the body flange can comprise wrinkles presenting a depth comprised between about 25 μm and 200 μm, in particular for a pod body presenting a diameter of about 48 mm.

In the present application
the term “pod” is used to broadly designate any kind of single-dose container suitable for preparing beverages or other edible products such as capsule, cartridge, portioned or individual package without limitation to the shape of this container, in particular the shape of the body, or the types of piercing means needed to extract the beverage therefrom.
the term “longitudinally” refers to the orientation of the two enclosing parts one to the other and their movement along the longitudinal axis XX′. Accordingly, the term “transversally” refers to the orientation that is transverse or perpendicular to that longitudinal orientation. Generally, the longitudinal and transverse orientations extend in a horizontal plane. The terms “lateral” is defined by reference to the vertical axis including the longitudinal axis XX′.
the term “vertically” and “downwardly” refers to the movement of the pod in the extraction device from its introduction above the two enclosing parts to its ejection below the two enclosing parts. The terms “upper” and “lower” refer to this vertical axis too. The terms “top” and “bottom” refers to this vertical axis when an element of the extraction is considered.
for the pod, the terms “top” and “bottom” are defined in accordance with the description of FIG. 1A.
the terms “upstream” and “downstream” refer to the path of liquid through the extraction device from the upstream enclosing part to the downstream enclosing part.

Generally, these terms are used to describe the relational positioning of features of the extraction device. These terms should be understood to refer to said device in its normal orientation when positioned in a beverage machine for the production of a beverage as shown in the FIGS. 2A, 2B, 3A, 3B and 3C.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIGS. 1A to 1D are different perspective view of pods used in the extraction device of the present invention,

FIGS. 2A and 2B are side and top views of a device according to the present invention in the closed position,

FIG. 3A is an isolated side view of the upstream and downstream pod enclosing parts of a device according to the present invention in the opened position,

FIG. 3B is an isolated side view of the upstream and downstream pod enclosing parts of FIG. 3A in the closed position,

FIG. 3C is an isolated side view of the upstream and downstream pod enclosing parts of FIG. 3A in the position of ejection of the pod,

FIG. 4A is an isolated perspective view of the downstream pod enclosing part of FIG. 3A,

FIG. 4B is an isolated perspective view of the downstream pod enclosing part of FIG. 3B,

FIG. 5 is an isolated perspective view of the upstream pod enclosing part of FIGS. 3A and 3B,

FIG. 6 is a longitudinal cross section of the FIG. 3B magnifying the area Z of interaction of the enclosing parts.

### DETAILED DESCRIPTION OF EXEMPLARY EMBODIMENTS

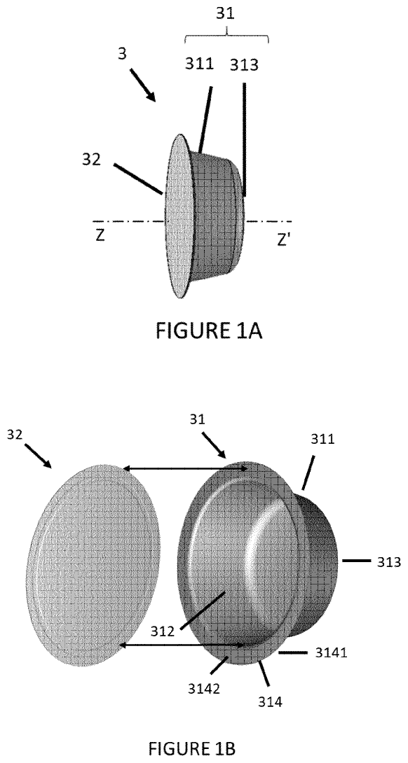

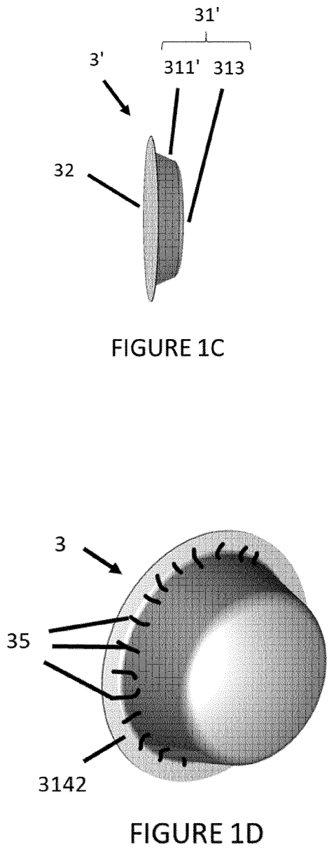

FIG. 1A (perspective view) and 1B (exploded view) illustrate the pods 3 that can be used in the extraction device of the invention.

The pod 3 comprises a pod body 31 with one sidewall 311 that extends axially from a bottom wall 313 towards a top. The sidewall 311 extends towards a top opening 312. At the top opening 312, the body comprises a circumferential annular flange 314 that extends radially outward from the sidewall 311 along the circumference of the opening 312.

The flange comprises an upper surface 3142 facing the top and a lower surface 3141.

Generally, any transversal cross section of the body is circular from the bottom to the top and the flange is circular too.

The body delimits a chamber for containing a beverage ingredient.

This beverage ingredient packed is preferably an ingredient able to be extracted like roast and ground coffee.

In a less preferred manner, the beverage ingredient can be tea leaves or a water soluble powder ingredient such as: instant coffee powder, milk powder, cream powder, instant tea powder, cocoa powder, soup powder, fruit powder or mixture of said powders or even a soluble liquid ingredient or a beverage concentrate such as a syrup or milk concentrate. The powders can be agglomerated or sintered.

The capsule comprises a lid 32 that is fixed, sealed or attached to at least a part of the upper surface 3142 of the circumferential flange and accordingly covers and closes the top opening 312.

The bottom wall 313 is adapted to be pierced so that liquid can be injected in the pod through the pierced openings.

The lid 32 is adapted to be opened by relative engagement with a piercing arrangement under the effect of the liquid pressure increase inside the pod during injection of liquid.

The pod shape is symmetric relatively to the central axial axis ZZ′ extending from the bottom wall to the lid and the pod shape is asymmetrical relatively to the plane of the lid and the flange.

FIG. 1C illustrates another pod 3′ that can be used in the extraction device of the invention and differ from the pod 3 of FIG. 1A only by the longitudinal size (along ZZ′) of the pod bodies 31′. The pod body 31 of the big pod 3 defines an ingredient chamber with a bigger volume than the pod body 31′ of the small pod 3′, the side wall 311 being higher than the side wall 311′. The diameter of the lids 32, 32′ of the small and big pods are identical.

This difference in sizes enable the preparation of different beverages, preferably different coffee beverages like ristretto, espresso, lungo (long cups), americano, . . .

Other sizes than those illustrated can be provided, like an intermediate size.

When the pod comprises roast and ground coffee, quantities of coffee can range between 4 and 15 g. The axial dimension of the pod can extend from 5 mm to 30 mm for a same diameter of the body of about 53 mm.

Preferably the pods 3 are essentially made of a biodegradable or compostable material, preferably a home compostable material since extracted coffee cakes can easily be made composted at home.

Preferably, the material of the pod comprises a paper layer. This paper layer is formable, i.e. a sheet of paper can be given a three-dimensional shape that is the form of the body of the above described pod. Contrary to common pods made of filter paper, this paper is thick and keep the three-dimensional shape provided during a shaping step of manufacturing of the pod.

Preferably, the paper layer of the pod can have a grammage of at least 20 g/m², preferably at most 150 g/m². The paper of the body can present a higher grammage than the paper of the lid because it needs to be stretched and deformed during manufacturing.

The grammage of the paper of the body can be comprised between 80 and 150 g/m².

The lid can present a grammage comprised between 20 and 120 g/m².

Both papers can present a grammage of about 100 g/m².

The material of the pod can comprise a layer of paper and some other materials to provide additional properties such as air barrier, stretchable or deformable properties. These additional properties can be provided with at least one plastic layer, for example as described in WO 2020/114995. Some additional layers of the body and of the lid can be different.

In fact, in order to shape the paper as a container for the beverage and to create a barrier to protect the beverage ingredient, the paper must be sufficiently thick. In addition, to create a barrier to atmosphere, in particular oxygen to which roast and ground coffee is particularly sensitive, the layer of paper is preferably coated with a compostable plastic film. Sealants layers are often necessary to attach the different layers and prevent delamination. For example, such a multilayer paper material can be the material described in WO 2020/114995 or in application WO2022/022899.

With such pod materials, the thickness of the multilayer paper material of the body can be about 200 μm and the thickness of the multilayer paper material of the lid can be about 140 μm which means that the thickness of the flange is usually greater than 200 μm, even greater than 300 μm.

The manufacturing of the pods comprises generally the steps of:
providing a first sheet of deformable paper material of circular shape, the diameter of said first sheet being adapted to the size of pod to be produced (small or big),
deforming said first sheet in order to shape the pod body with a flange therefrom. this operation is usually obtained by shaping the first sheet in a dedicated recess, die or mould that presents the shape of the pod body.
filling the shaped body with a dose of beverage ingredient, preferably roast and ground coffee, and preferably compacting said dose of roast and ground coffee inside the shaped pod,
providing a second sheet of material of circular shape, the diameter of said second sheet corresponding to the diameter of the lid of the pod, whatever the size of the pod to be produced (small or big),
sealing this second sheet on the flange of the filled shaped body.

Due to the nature of the paper material, that is an heterogenous material (random position of the plant fibres in the sheet), and due to the thickness of the paper material, the shaping of the first sheet of material produces pods with particular features that impact the preparation of a beverage within an extraction device.

The shaping of the paper material in a mould leads to the creation of wrinkles 35 all along the periphery of the side wall 311 and of the bottom face 3142 of the flange as illustrated in FIG. 1D. Within the bigger pods, the wrinkles are even more important and deeper since the original diameter of the first sheet is quite larger than the final diameter of the pod. For example, with a first sheet disc presenting a thickness of about 200 μm and a diameter of 70 mm and used to produce a final pod presenting a lid diameter of about 53 mm and a pod body diameter of about 48 mm (diameter below the flange of the flange), the depth of the wrinkles in the formed body can vary between 25 and 200 μm (measured with an interferometer). These wrinkles impact the tightness of the extraction chamber during the beverage preparation. Within the bigger pods (FIG. 1A), the wrinkles are even more important and deeper since the original diameter of the first sheet disc is quite larger than the final diameter of the pod. The depth of the more important wrinkles can reach almost 200 μm.

In addition, by shaping the first sheet of paper material by forcing a disc of this sheet in a mould, it was observed that the final diameter between the edges of the flange of the pod body was inconsistent. For example, to produce a final pod presenting a lid diameter of about 53 mm and a pod body diameter of about 48 mm with a first sheet presenting a thickness of about 200 μm and a diameter of 70 mm, it was observed that the diameter varied between 54.5 mm and 51.5 mm. These inconsistent values of the diameter impact the correct handling of the pod by the extraction device during the beverage preparation.

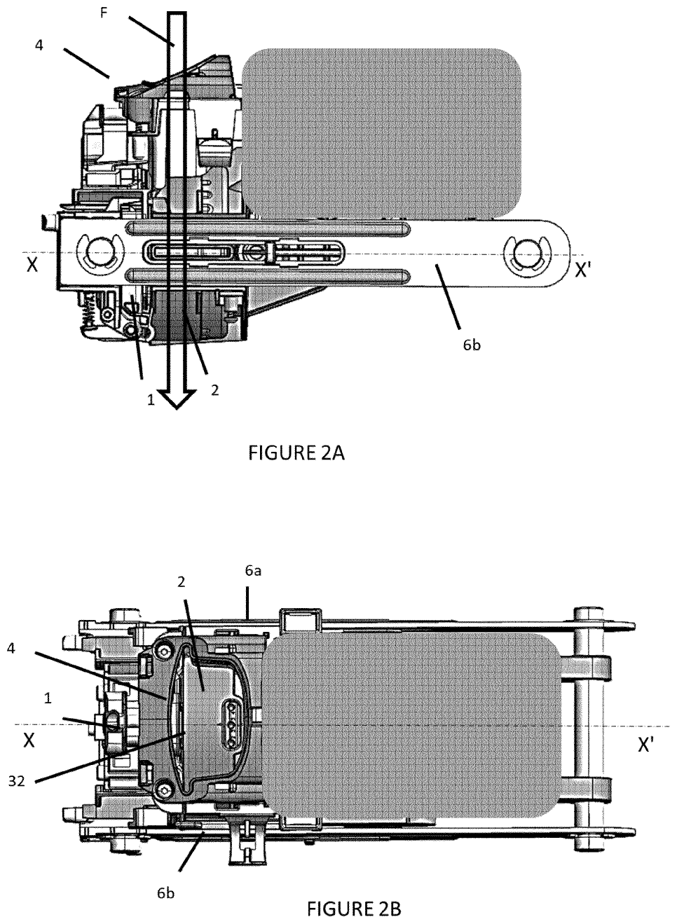

FIG. 2A is a side view of an extraction device according to the invention comprising an upstream pod enclosing part 2 and a downstream pod enclosing part 1 relatively translatable along a longitudinal axis XX. Usually, this axis XX′ is essentially horizontal. In FIG. 2A, these two parts are in a closed position and form an extraction chamber configured to enclose a pod during extraction. The pod is introduced through an insertion section 4 positioned above the two enclosing parts 1, 2, from which it can fall by gravity to these two enclosing parts 1, 2. After extraction, the pod can fall by gravity again below these two enclosing parts 1, 2 when they move apart one from the other. The arrow F illustrates the movement of the pod from the insertion inside the extraction device to the ejection from said device.

The two pod enclosing parts 1, 2 are hold and movable between two lateral and longitudinal metal sheets 6a, 6b. At least one of these parts is movable in translation between these two sheets in order to assess different relative and functional positions. In the preferred illustrated embodiments, the downstream enclosing part 1 is fixed and only the upstream enclosing part 2 is movable back and forth along the longitudinal axis XX.

FIG. 2B is a top view of the extraction device in the same relative positions of the upstream pod enclosing part 2 and the downstream pod enclosing part 1. The insertion section 4, in particular its housing, is designed to enable the introduction of the pod 2 with its lid 32 facing the downstream pod enclosing part 1 and accordingly the piercing arrangement 12 of said enclosing part as developed below. Consequently, the user is urged to position correctly the asymmetric pod 3 inside the extraction device.

Preferably, this insertion section 4 can comprise a recognition device to recognise or identify the pod 2 that is introduced inside the extraction device. The recognition device can comprise
a pod temporary blocking means to block the pod in a temporary recognition position, and
a device to recognise the pod blocked in this temporary recognition position.

The recognition device is configured to enable the pod temporary blocking means to let the pod fall to the pod holder of the extraction device once the pod has been recognised.

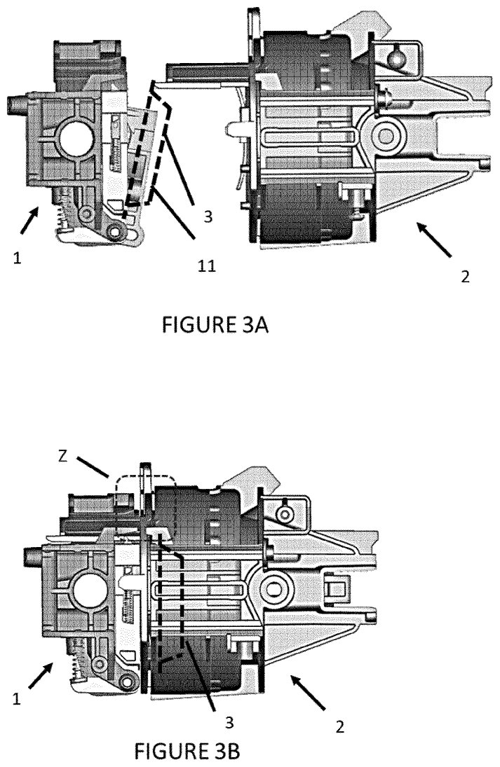

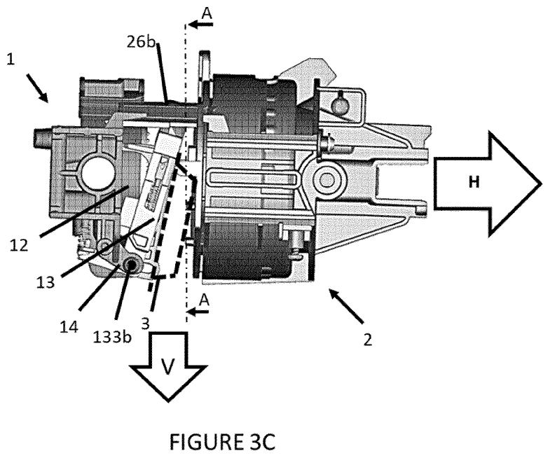

FIGS. 3A and 3B are isolated side views of the upstream and downstream pod enclosing parts 1, 2 of the extraction device of FIGS. 2A, 2B in different relative and functional positions.

In these isolated views, the insertion section 4 and the longitudinal sheets 6a, 6b were removed for a better vision of the different elements of the parts 1, 2. In addition, the position of the pod 3 is schematically illustrated in dotted lines.

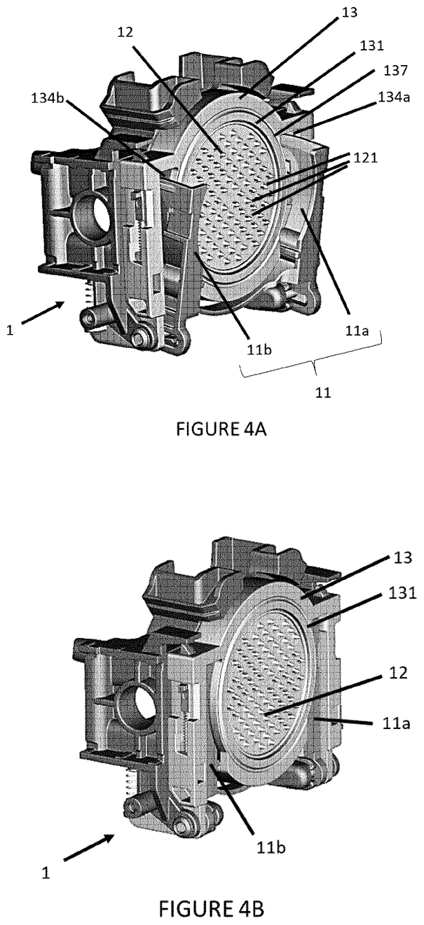

In FIG. 3A, the upstream and downstream pod enclosing parts 1, 2 are positioned in the open position for inserting a pod from the upper side. A pod holder 11 is visible in front of the downstream pod enclosing part 1 in a receiving position for receiving and holding the pod 3 as further described below in relation with FIG. 4A.

In FIG. 3B, the upstream and downstream pod enclosing parts 1, 2 are positioned in the closed position and form an extraction chamber enclosing a pod 3 during extraction. In that position, the pod holder 11 is in a retracted position as further described below in relation with FIG. 4B.

FIG. 4A is an isolated perspective view of the downstream pod enclosing part 2 of FIG. 3A. The downstream part 1 defines a plate perpendicular (that is transverse) to the longitudinal axis XX′. This plate comprises a central downstream plane piercing arrangement 12 for opening the lid 32 of the pod when the extracting liquid is introduced inside the pod and inflates the lid.

Usually, this central downstream plane piercing arrangement 12 is circular like the lid of the pod.

Opening happens by relative engagement of spikes with the lid under the effect of the rise in pressure of the injected liquid in the pod body chamber. This downstream plane piercing arrangement may comprise a rigid plate comprising opening elements 121 such as spikes, that can present the shape of cones or pyramids, optionally truncated at their ends, on its surface turned to the lid. In addition, the plate comprises traversing holes to evacuate the beverage dispensed from the opened lid to a tube or nozzle collecting and dispensing beverage to a drinking cup.

In addition, the plate comprises a peripheral area 13 surrounding that piercing arrangement 12.

The downstream part 1 comprises a pod holder 11 that is attached to the peripheral area 13.

While being attached, the pod holder can be moved between two positions. In FIG. 4A, the pod holder 11 is in the first position for receiving and holding the lid of the pod in front of the downstream plane piercing arrangement.

The pod holder 11 comprises a pair of elements 11a, 11b that retain and position the pod when this pair is in the first receiving position. In this position of the pod holder, these elements retain vertically the pod, that is they stop the vertical fall of the pod falling from the insertion position. In addition, in this position, these elements position the lid of the pod in front of the downstream plane piercing arrangement 12, that is these elements align or centre the lid of the pod with the downstream plane piercing arrangement 12. Actually, due to the asymmetric shape of the pod, the centre of gravity of the pod is placed outside the plane of the lid and the introduced pod tips over in the space between the two enclosing parts if it is not retained longitudinally too.

Usually the pair of elements 11a, 11b present symmetric shapes along the central vertical plane comprising the longitudinal axis XX.

The pair of retaining elements 11a, 11b are movable from the receiving position to a second retracted position at the lateral sides of the downstream plane piercing arrangement as illustrated in FIG. 4B that is an isolated perspective view of the downstream pod enclosing part 2 of FIG. 3B. In this situation, the pair of retaining and positioning elements 11a, 11b have been pushed from the receiving position to the retracted position by the upstream enclosing part 2 when said upstream enclosing part is being translated longitudinally from the open position to the closed position.

At the end this movement of the retaining elements 11a, 11b from the receiving position to the retracted position, the retaining elements are aligned on the lateral sides of the downstream plane piercing arrangement 12 in respective receiving areas 134a, 134b (see FIG. 4A) designed in the peripheral plate.

During this movement of the retaining elements, the pod is moved from a position where its lid 32 is slightly inclined versus the plane of the piercing arrangement 12 to a position where the lid 32 extends along said plane. During this movement, the retaining elements 11a, 11b passes from the side of the bottom face 3142 of the flange of the pod to the side of the top face 3141 of the flange of the pod. During this movement, the flange 314 of the pod is successively pressed, curved and then released by the retaining elements 11a, 11b.

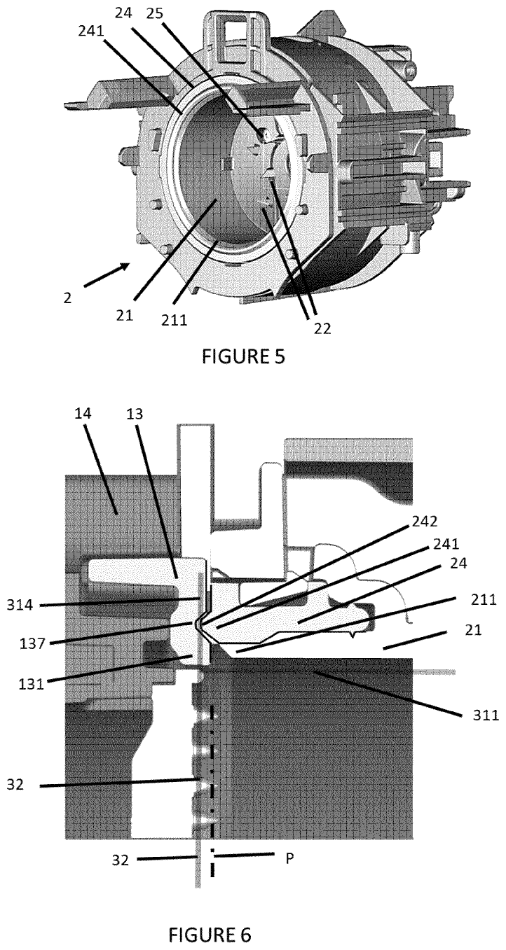

FIG. 5 is an isolated perspective view of the upstream pod enclosing part 2 of FIGS. 3A and 3B.

The upstream part defines an empty cage or cavity 21 for enclosing the pod body.

The upstream wall of the cage bears an upstream piercing arrangement 22 for opening the bottom wall 313 of the pod body. The upstream wall comprises at least one liquid injector 25 for supplying liquid into the pod through the holes opened in the bottom wall of the pod. This upstream piercing arrangement can comprise piercers in the form of blades. These blades can be designed and positioned to pierce the wall of the bottom of the pod body when the upstream and downstream pod enclosing parts are brought to the closed position as in FIG. 3B. The liquid injector 25, such as a shower at the upstream wall of the cage, can introduce the extracting liquid through the pre-pierced openings.

Since pods 2 of different sizes can be introduced and extracted, the bottom of the cage 21 can be made movable to adapt the cage internal volume to the pod, for example as described in WO 2020/089404.

When the upstream and downstream enclosing parts 1, 2 encloses a pod, the flange of the pod is hold between the periphery of the opened face of the upstream enclosing part and the peripheral area of the downstream enclosing part.

The edge 211 of the opened face of the cage is surrounded by a seal 24 to ensure tightness of the chamber formed by the two parts 1, 2 in the closed position, in particular to prevent liquid injected in the extraction chamber to leak around the flange of the pod hold in the chamber.

This seal 24 covers the periphery of the edge of the cage.

As illustrated in FIG. 6, instead of being flat, this seal 24 comprises a ridge 241 rising from the plane P of the opened face of the cage in direction of the downstream part. This ridge extends along the whole periphery of the seal.

According to the preferred embodiment, preferably the downstream part 2 comprises a groove 137, preferably conformal to the shape of the ridge of the seal, and that is configured to engage with said ridge 241 of the seal when the two enclosing parts 1, 2 are in the closed position and form the extraction chamber 5. This groove 137 can be designed in the peripheral area 13, in particular at the periphery of the central part 131.

The pods 3 (schematically illustrated in transparent lines 32, 311 in FIG. 6) used with the extraction device are configured to be positioned inside the extraction chamber so that the flange 314 extends diametrically outside the annular central part 131 with the consequence that, when a pod 3 is being enclosed inside the extraction chamber 5, the ridge 241 of the seal flattens the wrinkles in a more efficient manner than the flat area part of the seal area and forms a barrier for liquid. In addition, when the corresponding groove 137 is present, the ridge forces the central part of the annular flange 314 to enter inside the groove 137 along its whole periphery. As a result, the flange, which is the part of the pod comprising many wrinkles is stretched out between the ridge and the groove with the effect of flattening the material and reducing the wrinkles. In addition, the ridge closes paths for liquid through the channels formed by the wrinkles. The ridge is designed on the seal so that the top 242 of the ridge interacts with a central part of the flange of the pod introduced between the two pod enclosing parts. As a result, the two faces of the ridge extending from the top are used to flatten the wrinkles of the flange and the barrier for liquid is increased.

The seal is preferably made of a deformable and elastic material meaning that, when the two upstream and downstream parts are in the closed position, the ridge that pressed on the peripheral area of the downstream part is also deformed and flattened along the peripheral area which simultaneously improves the flattening of the wrinkles on the flange of the pod.

In an alternative and less preferred embodiment of the invention, the peripheral area of the plate of the downstream part can comprise a ridge that rises in the upstream direction and the the opened end of the cage defined by the upstream enclosing part is covered by a seal which is configured to be pressed against the peripheral area of the plate of the downstream part when the first and second enclosing parts are in the closed position. As a result, the flange of the pod is pressed between the ridge of the peripheral area and the seal when the two enclosing parts are in the closed position with the effect of closing the paths for liquid through the wrinkles of the pod.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

### LIST OF REFERENCES IN THE DRAWINGS

downstream enclosing part 1
pod holder 11
retaining and positioning elements 11a, 11b
downstream plate piercing arrangement 12
spikes 121
peripheral area 13
central part 131
receiving area 134a, 134b
groove 137
chassis 14
upstream enclosing part 2
cage 21
edge 211
upstream piercing arrangement 22
rising elements 23
seal 24
ridge 241
top 242
liquid injector 25
pod 3, 3′
body 31, 31′
side wall 311, 311′
top opening 312
bottom wall 313
annular flange 314
top face 3141
bottom face 3142
wrinkles 35
lid 32
beverage ingredient 33
insertion section 4
extraction chamber 5
lateral wall/sheet 6a, 6b

1. System comprising an extraction device and a pod,
wherein the pod comprises:
a pod body, said pod body comprising:
a side wall and a bottom wall defining a chamber, said chamber extending axially between the bottom and a top opening,
a circumferential annular flange projecting radially outward from the top opening, said flange comprising an upper surface opposite to the chamber with respect to the opening,
said pod body containing a beverage ingredient,
and
a top lid attached to the upper surface of the circumferential flange, said top lid closing the top opening of the pod body,
and
wherein the extraction device comprises:
upstream and downstream pod enclosing parts relatively translatable along a longitudinal axis (XX′) between an open position for inserting and/or ejecting the pod and a closed position for forming an extraction chamber enclosing the pod during extraction,
the upstream part defining a cage and bearing an upstream piercing arrangement for opening the bottom wall of the pod and a liquid injector,
the downstream part defining a plate transverse to the longitudinal axis (XX′), said plate comprising:
a downstream plane piercing arrangement for opening the lid of the pod,
and
a peripheral area,
and
an insertion section for inserting the pod in the device, said insertion section being designed to position the pod with the lid facing the downstream piercing arrangement, and
wherein the periphery of the opened end of the cage defined by the upstream enclosing part is covered by a seal, and
said seal is configured to be pressed against the peripheral area of the plate of the downstream part when the first and second enclosing parts are in the closed position, and
said seal comprises a ridge, said ridge rising in the downstream direction, and
wherein, in the closed position of the downstream and the upstream enclosing parts a central part of the flange of the pod is pinched by the ridge of the seal of the upstream enclosing part against the peripheral area of the plate of the downstream part.

2. A system according to claim 1, wherein the peripheral area of the downstream enclosing part comprises a groove and, when the upstream and downstream pod enclosing parts are in the closed position, the ridge faces said groove.

3. System according to claim 1, wherein the body and the lid of the pod are made of paper material.

4. System according to claim 1, wherein the body is made of a paper material presenting a thickness of at least 100 μm.

5. System according to a claim 1, wherein the pod body is manufactured by forcing a disc of paper material in a mould.

6. System according to claim 1, wherein the bottom face of the body flange comprises wrinkles, said wrinkles presenting a depth comprised between about 25 μm and 200 μm.

7. System according to claim 1, wherein the extraction device is part of a beverage preparation machine.

8. A device for extracting a beverage ingredient by supplying an extraction liquid such as heated water into in a pod, said pod comprising:
a pod body, said pod body comprising:
a side wall and a bottom wall defining a chamber, said chamber extending axially between the bottom and a top opening,
a circumferential annular flange projecting radially outward from the top opening, said flange comprising an upper surface opposite to the chamber with respect to the opening,
said pod body containing a beverage ingredient,
and
a top lid attached to the upper surface of the circumferential flange, said top lid closing the top opening of the pod body,
wherein said device comprises:
upstream and downstream pod enclosing parts relatively translatable along a longitudinal axis (XX′) between an open position for inserting and/or ejecting the pod and a closed position for forming an extraction chamber enclosing the pod during extraction,
the upstream part defining a cage and bearing an upstream piercing arrangement for opening the bottom wall of the pod and a liquid injector,
the downstream part defining a plate transverse to the longitudinal axis (XX′), said plate comprising:
a downstream plane piercing arrangement for opening the lid of the pod,
and
a peripheral area,
and
an insertion section for inserting the pod in the device, said insertion section being designed to position the pod with the lid facing the downstream piercing arrangement, and
wherein the periphery of the opened end of the cage defined by the upstream enclosing part is covered by a seal, and
said seal is configured to be pressed against the peripheral area of the plate of the downstream part when the first and second enclosing parts are in the closed position, and
said seal comprises a ridge, said ridge rising in the downstream direction, and
wherein the peripheral area of the downstream enclosing part comprises a groove, said groove presenting a shape conformal to the shape of the ridge of the seal and, when the upstream and downstream pod enclosing parts are in the closed position, the ridge faces said groove.

9-15. (canceled)
